(19) United States
(12) Patent Application Publication
(10) Pub. No.: US 2022/0311871 A1
(43) Pub. Date: Sep. 29, 2022

(54) UE Provisioning and Charging for Sidelink Group Communication

(71) Applicant: Apple Inc., Cupertino, CA (US)

(72) Inventors: Sudeep MANITHARA VAMANAN, Nuremberg (DE); Haijing HU, Los Gatos, CA (US); Krisztian KISS, Hayward, CA (US); Yuqin CHEN, Beijing (CN); Zhibin WU, Los Altos, CA (US)

(21) Appl. No.: 17/593,728

(22) PCT Filed: Aug. 11, 2020
(86) PCT No.: PCT/CN2020/108390

§ 371 Date: Sep. 23, 2021

(51) Int. Cl. H04M 15/00; H04W 8/00; H04W 4/24

(52) U.S. Cl. CPC H04M 15/66; H04W 8/005; H04W 4/24; H04W 92/18

(57) ABSTRACT

A network may provision a user equipment (UE) with charging rules for the UE to host sidelink (SL) communications with other UEs. An application server may receive information indicating a group of user equipment (UE) has been formed, the group of UEs comprising a first UE connected to a radio access network (RAN) and at least one further UE connected via a sidelink (SL) to the first UE, select SL parameters including session management parameters and charging parameters for a SL session for the UE group and provision a policy control function (PCF) of a core network (CN) with the selected SL parameters.

### BACKGROUND INFORMATION

A user equipment (UE) may be configured with multiple communication links. For example, the UE may receive a signal from a cell of a corresponding network over a downlink and may transmit a signal to the cell of the corresponding network over an uplink. The UE may also be configured to communicate with a further UE via a sidelink (SL). The term sidelink refers to a communication link that may be utilized for device-to-device (D2D) communication. Thus, the SL may facilitate communication between the UE and the further UE without the involvement of a network cell.

During an interactive service comprising multiple UEs, e.g. a network controlled interactive service (NCIS) for interactive gaming, the UEs may comprise different roles within the service. For example, one or more UEs may be a session leader (or “primary UE”) utilizing network resources to execute the service, while other ones of the group of UEs, e.g., “secondary UEs” may be connected to the primary UE(s) through a SL, and may not be connected directly to a network. The primary UE may incur a data usage and/or utilize network resources that the secondary UEs may avoid. Mobile network operators (MNOs) may desire to establish charging/billing rules for allocating the cost of the service amongst the group of UEs.

### SUMMARY

Some exemplary embodiments are related to an application server having one or more processors configured to perform operations. The operations include receiving information indicating a group of user equipment (UE) has been formed, the group of UEs comprising a first UE connected to a radio access network (RAN) and at least one further UE connected via a sidelink (SL) to the first UE, selecting SL parameters including session management parameters and charging parameters for a SL session for the UE group and provisioning a policy control function (PCF) of a core network (CN) with the selected SL parameters.

Other exemplary embodiments are related to a network component having one or more processors configured to perform operations. The operations include receiving, from an application server (AS), a provisioning of sidelink (SL) parameters for an interactive service for a user equipment (UE) group comprising a first UE and at least one further UE connected via a SL to the first UE, the SL parameters including session management parameters and charging parameters for a SL session for the UE group, translating at least a portion of the SL parameters into policy rules comprising session management rules and charging rules and providing, for the first UE, the policy rules for the SL session.

Still further exemplary embodiments are related to a network component having one or more processors configured to perform operations. The operations include establishing a first protocol data unit (PDU) session for communications between a core network (CN) and a user equipment (UE), receiving, from a policy control function (PCF), a provisioning of policy rules for a UE group comprising the UE and at least one further UE connected via a sidelink (SL) to the UE, wherein the policy rules comprise session management rules and charging rules for an interactive service, establishing a second PDU session for the UE group based on the policy rules and when the group PDU session ends, determining a duration of the second PDU session in accordance with the policy rules.

Additional exemplary embodiments are related to a user equipment (UE) having one or more processors configured to perform operations. The operations include establishing a UE group comprising the UE and at least one further UE for an interactive service where the at least one further UE is connected to the UE via a sidelink (SL), receiving a provisioning of policy rules for the interactive service, wherein the policy rules comprise session management rules and charging rules for the interactive service, establishing, based on the policy rules, a protocol data unit (PDU) session with a session management function (SMF) for the interactive service, performing the interactive service with the at least one further UE via the SL and when the interactive service ends, reporting a duration for the PDU session to the SMF.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary network arrangement comprising a first UE (UE1) having a connection to the NG-RAN and two other UEs (UE2 and U3) having sidelink connections to UE1.

FIG. 4 shows a call flow for an operation to provision a network and a user equipment (UE) with path selection and charging rules parameters for a sidelink (SL) group communication in which the UE is involved.

### DETAILED DESCRIPTION

The exemplary embodiments may be further understood with reference to the following description and the related appended drawings, wherein like elements are provided with the same reference numerals. The exemplary embodiments relate to a network tracking a duration of a sidelink (SL) session, for example a group interactive service, in accordance with charging rules for a user equipment (UE) connected to the network.

The exemplary embodiments are described with regard to a UE. However, the use of a UE is merely provided for illustrative purposes. The exemplary embodiments may be utilized with any electronic component that is configured with the hardware, software, and/or firmware to exchange information (e.g., control information) and/or data with the network. Therefore, the UE as described herein is used to represent any suitable electronic device.

The exemplary embodiments are also described with regard to a sidelink (SL). The term “sidelink” generally refers to a communication link between the UE and a further UE. The SL provides direct device-to-device (D2D) communication where information and/or data exchanged between the UE and the further UE via the sidelink does not go through a cell. In some configurations, a single SL provides bidirectional data communication between the UE and the further UE. In other configurations, a single SL provides unidirectional data communication between the UE and the further UE, although signaling may be transmitted in both directions. The term “unicast” refers to one-to-one, i.e. D2D, device communication and generally may refer to either bidirectional or unidirectional communication. Various embodiments may apply to either one or both forms of communication as indicated below.

SL communications are supported by both Long-Term Evolution (LTE) and 5G new radio (NR) standards. In some configurations, the network may provide information to the UE that indicates how an SL is to be established, maintained and/or utilized. Thus, while the information and/or data exchanged over the SL does not go through a cell, the UE and the network may exchange information associated with the SL via the network cell. In other configurations, an SL is not under the control of the network. In either configuration, the first UE and the second UE may still perform synchronization procedures, discovery procedures and exchange control information corresponding to the SL.

Network Controlled Interactive Services (NCIS) relates to services where data is exchanged between users involved in a same NCIS session, such as for interactive gaming. User equipment (UEs) in a same NCIS session are grouped together as one NCIS group and share certain information. An NCIS group may comprise users in a local area or users remote from one another, as well as users from a same mobile network operator (MNO) or different MNOs.

NCIS allows UEs from same or different MNOs to perform sidelink (SL) communications. Some interactive services may require low latency SL bearers, e.g. PC5 bearers, implying that SL communications for the services take place over a network managed PDU session. At least one of the UEs in an NCIS group has to be connected to the network to act as a primary UE, while secondary UEs in the NCIS group may have SLs to the primary UE and no connection to a network.

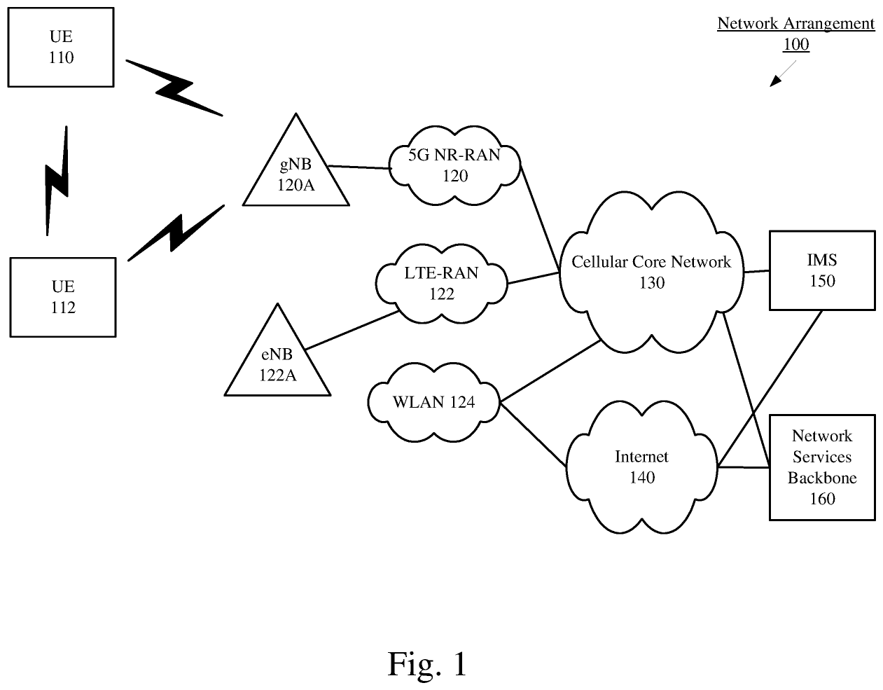

FIG. 1 shows an exemplary network arrangement 100 according to various exemplary embodiments. The exemplary network arrangement 100 includes UEs 110, 112. Those skilled in the art will understand that the UEs 110, 112 may be any type of electronic component that is configured to communicate via a network, e.g., a component of a connected car, a mobile phone, a tablet computer, a smartphone, a phablet, an embedded device, a wearable, an Internet of Things (IoT) device, etc.

Throughout this description, the terms UE 110, UE and transmitting device may be used interchangeably. Additionally, the terms UE 112, further UE and receiving device may be also used interchangeably. It should also be understood that an actual network arrangement may include any number of UEs being used by any number of users. Thus, the example of two UEs 110, 112 is merely provided for illustrative purposes.

The UEs 110, 112 may communicate directly with one or more networks. In the example of the network configuration 100, the networks with which the UEs 110, 112 may wirelessly communicate are a 5G NR radio access network (5G NR-RAN) 120, an LTE radio access network (LTE-RAN) 122 and a wireless local access network (WLAN) 124. These types of networks support vehicle-to-everything (V2X) and/or sidelink (SL) communication. In the exemplary network arrangement 100, the UEs 110 and 112 are connected via SL. However, the UE 110 may also communicate with other types of networks and the UE 110 may also communicate with networks over a wired connection. Therefore, the UEs 110, 112 may include a 5G NR chipset to communicate with the 5G NR-RAN 120, an LTE chipset to communicate with the LTE-RAN 122 and an ISM chipset to communicate with the WLAN 124.

The 5G NR-RAN 120 and the LTE-RAN 122 may be portions of cellular networks that may be deployed by cellular providers (e.g., Verizon, AT&T, T-Mobile, etc.). These networks 120, 122 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set. The WLAN 124 may include any type of wireless local area network (WiFi, Hot Spot, IEEE 802.11x networks, etc.).

The UEs 110, 112 may connect to the 5G NR-RAN via the gNB 120A. Reference to a single gNB 120A is merely for illustrative purposes. The exemplary embodiments may apply to any appropriate number of gNBs. The UEs 110, 112 may also connect to the LTE-RAN 122 via the eNB 122A.

Those skilled in the art will understand that any association procedure may be performed for the UEs 110, 112 to connect to the 5G NR-RAN 120 and the LTE-RAN 122. For example, as discussed above, the 5G NR-RAN 120 and the LTE-RAN 122 may be associated with a particular cellular provider where the UEs 110, 112 and/or the user thereof has a contract and credential information (e.g., stored on a SIM card). Upon detecting the presence of the 5G NR-RAN 120, the UEs 110, 112 may transmit the corresponding credential information to associate with the 5G NR-RAN 120. More specifically, the UEs 110, 112 may associate with a specific base station (e.g., the gNB 120A of the 5G NR-RAN 120, the eNB 122A of the LTE-RAN 122).

The UEs 110, 112 may also communicate with one another directly using a sidelink. The sidelink is a direct D2D communication link. Thus, the information and/or data transmitted directly to the other endpoint (e.g., the UE 110 or the UE 112) does not go through a cell (e.g., gNB 120A, eNB 122A). In some embodiments the UEs 110, 112 may receive information from a cell regarding how the sidelink is to be established, maintained and/or utilized. Thus, a network (e.g., the 5G NR-RAN 120, LTE-RAN 122) may control the sidelink. In other embodiments, the UEs 110, 112 may control the sidelink. Regardless of how the sidelink is controlled, the UEs 110, 112 may maintain a downlink/uplink to a currently camped cell (e.g., gNB 120A, eNB 122A) and a sidelink to the other UE simultaneously.

In addition to the networks 120, 122 and 124 the network arrangement 100 also includes a cellular core network 130, the Internet 140, an IP Multimedia Subsystem (IMS) 150, and a network services backbone 160. The cellular core network 130 may be considered to be the interconnected set of components that manages the operation and traffic of the cellular network, e.g. the 5GC in NR. The cellular core network 130 also manages the traffic that flows between the cellular network and the Internet 140. Network entities related to the 5GC include an access and mobility management function (AMF), a session management function (SMF), a network exposure function (NEF), and a policy control function (PCF). There may also be an application function (AF) that may be part of the cellular core network 130 or may be an entity that is external to the cellular core network 130. An AF that is external to the cellular core network 130 may be, for example, an interactive service server, a gaming application server, etc. The external AF may interact with the network entities in the cellular core network 130 to influence the communication both to/from the network and towards other UEs over the sidelink.

The AMF may be responsible for registration management (e.g., for registering a UE with the network) and connection management. The AMF may provide transport for session management (SM) messages between the UE and the SMF, and act as a transparent proxy for routing SM messages. The AMF may also handle N2 signaling from the SMF and the AMF for PDU sessions and QoS. The UE needs to register with the AMF to receive network services. Registration management (RM) is used to register or deregister the UE with the network (e.g., the AMF), and establish a UE context in the network.

The SMF may be responsible for session management (SM) (e.g., session establishment, modify and release). SM may refer to management of a PDU session, and a PDU session or “session” may refer to a PDU connectivity service that provides or enables the exchange of PDUs between a UE 801 and a data network (DN) identified by a data network name (DNN). PDU sessions may be established upon UE request, modified upon UE or 5GC request, and released upon UE or 5GC request. Upon request from an application server (AS), the 5GC may trigger a specific application in the UE. In response to receipt of the trigger message, the UE may pass the trigger message (or relevant parts/information of the trigger message) to one or more identified applications in the UE. The identified application(s) in the UE may establish a PDU session to a specific DNN. The SMF may check whether the UE requests are compliant with user subscription information associated with the UE. In this regard, the SMF may retrieve and/or request to receive update notifications on SMF level subscription data from the unified data management (UDM). The SMF may support interactions with external DNs for transport of signaling for PDU session authorization/authentication by the external DN.

The NEF may provide means for securely exposing the services and capabilities provided by 3GPP network functions for third party, internal exposure/re-exposure, Application Functions (AF), edge computing or fog computing systems, etc. In such embodiments, the NEF may authenticate, authorize, and/or throttle the AFs. NEF may also translate information exchanged with the AF and information exchanged with internal network functions.

The PCF may provide policy rules to control plane function(s) to enforce them and may also support unified policy frameworks to govern network behavior. The PCF may communicate with the AMF, the SMF and the AF.

AFs may provide application influence on traffic routing and interact with the policy framework for policy control. The AF acts as a quality controller for specific applications residing on the network, and interconnects with the PCF. The AF may exchange information with the 5GC via the NEF, which may be used for edge computing implementations.

The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

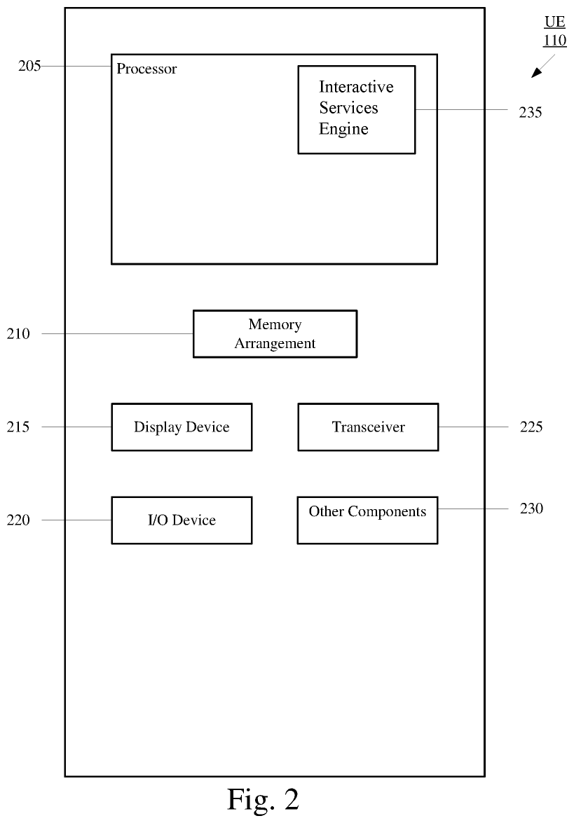

FIG. 2 shows an exemplary UE 110 according to various exemplary embodiments. The UE 110 will be described with regard to the network arrangement 100 of FIG. 1. The UE 110 may include a processor 205, a memory arrangement 210, a display device 215, an input/output (I/O) device 220, a transceiver 225, and other components 230. The other components 230 may include, for example, a SIM card, an embedded SIM (eSIM), an audio input device, an audio output device, a power supply, a data acquisition device, ports to electrically connect the UE 110 to other electronic devices, etc. The UE 110 illustrated in FIG. 2 may also represent the UE 112.

The processor 205 may be configured to execute a plurality of engines of the UE 110. For example, the engines may include an interactive services engine 235. The interactive services engine 235 may perform operations including establishing a PDU session for an application-specific group communication. Further, the interactive services engine 235 may report certain parameters of the group communication, such as a session duration, to the SMF, to be described in further detail below.

The above referenced engines each being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G NR-RAN 120, the WLAN 122, etc. Accordingly, the transceiver 225 may operate on a variety of different frequencies or channels (e.g., set of consecutive frequencies).

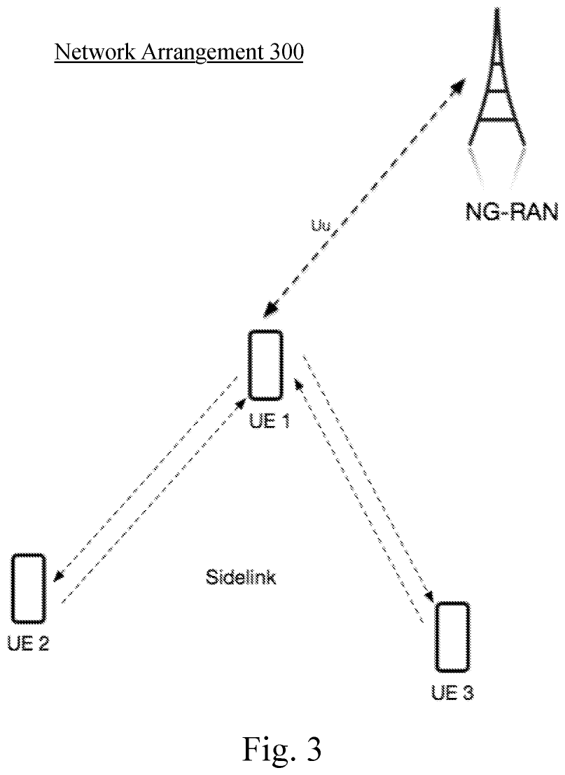

FIG. 3 shows an exemplary network arrangement 300 comprising a first UE (UE1) having a connection to the NG-RAN and two other UEs (UE2 and U3) having sidelink connections to UE1. The primary UE, UE1 in this example, may incur a data usage and/or utilize network resources that the secondary UEs, UE2 and UE3, connected only through SLs to the primary UE, may avoid. Thus, MNOs may establish charging/billing rules for allocating the cost of the NCIS amongst the UEs. Charging may be based on e.g. data volume.

According to various exemplary embodiments described herein, the network may track a duration of a SL session (e.g. group interactive service) in accordance with charging rules for a user equipment (UE) connected to the network. The session duration may be determined by (or received from the UE at) the session management function (SMF) in accordance with session management (SM) and/or charging rules provided by the policy control function (PCF) and configured for the UE by the SMF. The PCF communicates with an application server (AS) and receives SL session management parameters (e.g. path selection information/traffic routing rules) and charging parameters for the interactive service, with which the PCF provisions the SMF for the SL session.

The PCF further provisions the UE with UE policy rules for the SL including, e.g. the session management rules and the charging rules. In some embodiments, based on the charging rules, the SMF identifies the start of the SL session and the end of the SL session for determining a duration of the session. In alternate embodiments, the UE is provisioned to report SL usage-related information to the SMF.

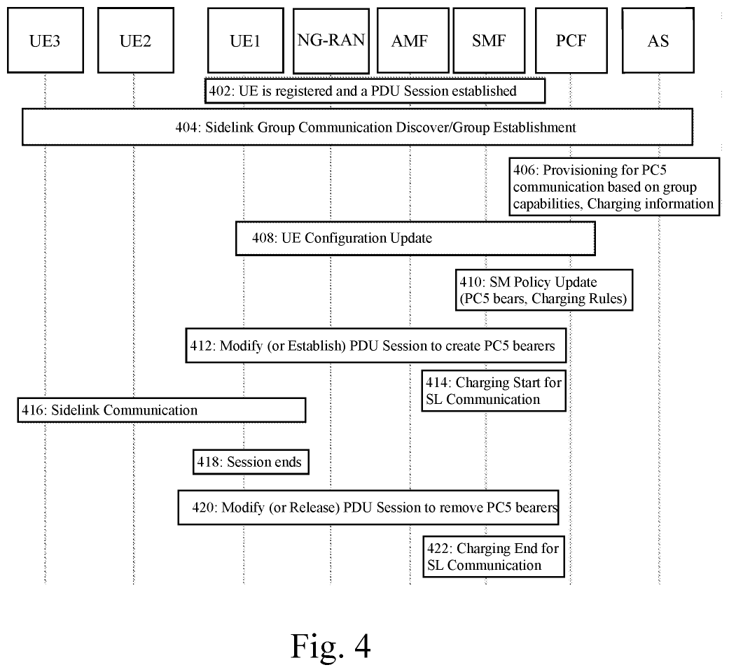

FIG. 4 shows a call flow 400 for an operation to provision a network and a user equipment (UE) with path selection and charging rules for a sidelink (SL) group communication in which the UE is involved. The end-to-end operation relies, in part, on existing procedures defined for 5GS.

The entities involved in the call flow 400 include three UEs, e.g., a UE1, a UE2 and a UE3 communicating in an interactive service. The three UEs may be configured similarly to those described above with respect to FIG. 3, to be described in detail below. However, in other embodiments, other numbers of UEs may be participating in the interactive service, e.g. an NCIS session. The call flow 400 also includes the NR RAN, the AMF, the SMF, the PCF and an application server (AS) acting as an AF.

In 402, the UE1 is registered and has a PDU session established for communication with the NR RAN via a Uu interface. As discussed above, the PDU session may be managed by the SMF via the AMF.

In 404, the UE1 performs a discovery procedure for UEs interested in performing an application-specific group communication and discovers the UE2 and UE3. The discovery procedure may be performed using parameters provisioned previously by the application server (AS) or pre-configured in the UE. In this example, it may be considered that a group is established comprising UE1, UE2 and UE3, with UE1 acting in a primary role and the UE2 and UE3 acting in a secondary role via SLs to the UE1. The UE1 may inform the AS, which may be acting as an AF for the 3GPP network (of which UE1 is a subscriber), that the group has been established. In other exemplary embodiments, the AS may obtain the information that the group has been formed from the 5G Direct Discovery Name Management Function (DDNMF) (not shown), if deployed by the MNO.

In 406, the AS is triggered (based on the establishment of the group) to provision the PCF, either directly or through the NEF, with session management parameters and charging parameters, e.g., parameters used for sidelink group communication and charging. The session management parameters and charging parameters may also be associated with a validity time, e.g., a duration of time for which the parameters remain valid. The session management parameters and charging parameters may be influenced by the respective capabilities of the group member UEs (e.g., the role of the UE in the group) provided to the AS in 404.

In 408, the PCF translates the information provided by the AF into UE policy rules and provisions the UE1. These rules may contain traffic routing rules for PC5 path selection, which are then provisioned to the UE using existing methods, e.g. those defined in TS 23.502 Sec 4.2.4.3. The PC5 interface is specified for one-to-many group communications, e.g. SL communications, and has an associated bearer-level security mechanism (PC5 bearers). If a UE-based reporting of SL usage for communication is used by the network, these rules are also configured by the PCF as part of this provisioning. For example, the UE may be provisioned to report a duration of the SL session.

In 410, the PCF further provisions the session management rules and charging rules to the SMF. For example, the charging rules may include rules in which a duration of the SL session is used as a parameter for charging.

In 412, the UE, based on the provisioned application traffic routing rules, initiates either a PDU session establishment (for e.g. a sidelink specific DNN) or a modification of an existing PDU session (e.g., to add SL PC5 bearers). A PDU session is established or modified according to the SM rules provided to the SMF from the PCF. If a PDU session modification is initiated, it may be triggered by the SMF. For the SL bearers, the SMF requests the NR RAN (through the AMF) to assign resources. In another embodiment, the SMF may ask the NR RAN to report the SL frequencies where resources are assigned. The NR RAN confirms the assignment of the resources for the new PDU session or the modified PDU Session. If requested by the SMF, the NR RAN may additionally include configured SL frequencies in the confirmation to the SMF.

In 414, upon confirmation from NR RAN, the SMF marks the start of a SL session. This step allows the SMF to track a session duration for the interactive service for the purpose of charging, based on the charging rules provisioned by PCF. In an alternative embodiment, the duration of the SL session may also be reported by the UE. In this embodiment, the rules of reporting the duration of the SL session is provided to the UE in 508.

In 416, the UE1, UE2 and UE3 perform the interactive service via SL communication. It is noted that the UE2 and UE3, in some embodiments, may also have a network connection and be provisioned with charging rules, similar to the UE1.

In 418, the SL communication ends. The end of the sidelink communication may be triggered by the application, the UE1 moving out of proximity of the network and/or the further UEs, or the expiry of the validity time of the provisioned session management rules and charging rules.

In 420, the end of the SL communication triggers a release of the PDU session (if established only for SL communication) or a modification of the PDU session (e.g. to remove the PC5 bearers).

In 422, upon the release or the modification of the PDU session, the SMF marks the SL session as ended, according to charging rules. If configured to report SL usage-related information, the UE sends this information to the SMF at this stage.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. In a further example, the exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalents.

1. An application server, comprising:
one or more processors configured to perform operations comprising:
receiving information indicating a group of user equipment (UE) has been formed, the group of UEs comprising a first UE connected to a radio access network (RAN) and at least one further UE connected via a sidelink (SL) to the first UE;
selecting SL parameters including session management parameters and charging parameters for a SL session for the UE group; and
provisioning a policy control function (PCF) of a core network (CN) with the selected SL parameters.

2. The application server of claim 1, wherein the information is received from the first UE.

3. The application server of claim 1, wherein the information is received from a Direct Discovery Name Management Function (DDNMF) of a network operator.

4. The application server of claim 1, wherein the application server serves a role as an application function (AF) to a cellular network to which the first UE is subscribed.

5. The application server of claim 1, wherein the SL parameters are valid for a predetermined period of time.

6. The application server of claim 1, wherein the information includes capability information for one or more of the UEs of the group of UEs.

7. The application server of claim 6, wherein the selecting the SL parameters is based on, at least, the capability information for the one or more of the UEs.

8. A network component, comprising:
one or more processors configured to perform operations comprising:
receiving, from an application server (AS), a provisioning of sidelink (SL) parameters for an interactive service for a user equipment (UE) group comprising a first UE and at least one further UE connected via a SL to the first UE, the SL parameters including session management parameters and charging parameters for a SL session for the UE group;
translating at least a portion of the SL parameters into policy rules comprising session management rules and charging rules; and
providing, for the first UE, the policy rules for the SL session.

9. The network component of claim 8, wherein the operations further comprise:
provisioning a session management function (SMF) of a core network (CN) with the policy rules so that the SMF can determine a duration of the SL session in accordance with the charging rules.

10. The network component of claim 8, wherein the policy rules comprise a rule indicating the first UE is to report SL usage.

11. The network component of claim 8, wherein the policy rules comprise a rule indicating the first UE is to report a duration of the SL session.

12. The network component of claim 8, wherein the network component comprises a policy control function (PCF) of a core network.

13. A network component, comprising:
one or more processors configured to perform operations comprising:
establishing a first protocol data unit (PDU) session for communications between a core network (CN) and a user equipment (UE);
receiving, from a policy control function (PCF), a provisioning of policy rules for a UE group comprising the UE and at least one further UE connected via a sidelink (SL) to the UE, wherein the policy rules comprise session management rules and charging rules for an interactive service;
establishing a second PDU session for the UE group based on the policy rules; and
when the group PDU session ends, determining a duration of the second PDU session in accordance with the policy rules.

14. The network component of claim 13, wherein determining the duration of the second PDU session comprises identifying a start time of the second PDU session and an end time of the second PDU session.

15. The network component of claim 14, wherein the operations further comprise:
receiving a confirmation from a radio access network (RAN) to which the UE is connected of a resource assignment for the interactive service; and
when the confirmation is received, the identifying the start time of the second PDU session.

16. The network component of claim 15, wherein the operations further comprise:
requesting the RAN to provide SL frequency parameters configured for the interactive service.

17. The network component of claim 13, wherein the duration of the second PDU session is determined from a report received from the UE.

18. The network component of claim 13, wherein the second PDU session is one of a new PDU session or a modification of the first PDU session.

19. The network component of claim 18, wherein modifying the first PDU session includes adding SL bearers to the first PDU session.

20. (canceled)
